(19) United States
(12) Patent Application Publication
(10) Pub. No.: US 2010/0150022 A1
(43) Pub. Date: Jun. 17, 2010

(54) System and Method for a Relay Protocol Stack

(75) Inventors: Zhijun CAI, Euless, TX (US); James Earl WOMACK, Bedford, TX (US); Yi YU, Irving, TX (US)

Correspondence Address: Research in Motion Corp./CR;Attn: J. Robert Brown, 5601 Granite Parkway, Suite 750, Plano, TX, 75024, US

(73) Assignee: Research in Motion Corporation, Irving, TX (US)

(21) Appl. No.: 12/337,222

(22) Filed: Dec. 17, 2008

(51) Int. Cl. H04L 12/28

(52) U.S. Cl. 370/254

(57) ABSTRACT

A layer two relay node having a relay radio resource configuration entity. The relay radio resource configuration entity is configured to receive resource configuration information from an access node.

### BACKGROUND

As used herein, the terms “user agent” and “UA” might in some cases refer to mobile devices such as mobile telephones, personal digital assistants, handheld or laptop computers, and similar devices that have telecommunications capabilities. Such a UA might consist of a UA and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UA might consist of the device itself without such a module. In other cases, the term “UA” might refer to devices that have similar capabilities but that are not transportable, such as desktop computers, set-top boxes, or network appliances. The term “UA” can also refer to any hardware or software component that can terminate a communication session for a user. Also, the terms “user agent,” “UA,” “user equipment,” “UE,” “user device” and “user node” might be used synonymously herein.

As telecommunications technology has evolved, more advanced network access equipment has been introduced that can provide services that were not possible previously. This network access equipment might include systems and devices that are improvements of the equivalent equipment in a traditional wireless telecommunications system. Such advanced or next generation equipment may be included in evolving wireless communications standards, such as long-term evolution (LTE). For example, an LTE system might include an enhanced node B (eNB), a wireless access point, or a similar component rather than a traditional base station. As used herein, the term “access node” will refer to any component of the wireless network, such as a traditional base station, a wireless access point, or an LTE eNB, that creates a geographical area of reception and transmission coverage allowing a UA or a relay node to access other components in a telecommunications system. In this document, the term “access node” and “access device” may be used interchangeably, but it is understood that an access node may comprise a plurality of hardware and software.

The term “access node” does not refer to a “relay node,” which is a component in a wireless network that is configured to extend or enhance the coverage created by an access node or another relay node. The access node and relay node are both radio components that may be present in a wireless communications network, and the terms “component” and “network node” may refer to an access node or relay node. It is understood that a component might operate as an access node or a relay node depending on its configuration and placement. However, a component is called a “relay node” only if it requires the wireless coverage of an access node or other relay node to access other components in a wireless communications system. Additionally, two or more relay nodes may used serially to extend or enhance coverage created by an access node.

An LTE system can include protocols such as a Radio Resource Control (RRC) protocol, which is responsible for the assignment, configuration, and release of radio resources between a UA and a network node or other LTE equipment. The RRC protocol is described in detail in the Third Generation Partnership Project (3GPP) Technical Specification (TS) 36.331. According to the RRC protocol, the two basic RRC modes for a UA are defined as “idle mode” and “connected mode.” During the connected mode or state, the UA may exchange signals with the network and perform other related operations, while during the idle mode or state, the UA may shut down at least some of its connected mode operations. Idle and connected mode behaviors are described in detail in 3GPP TS 36.304 and TS 36.331.

The signals that carry data between UAs, relay nodes, and access nodes can have frequency, time, and coding parameters and other characteristics that might be specified by a network node. A connection between any of these elements that has a specific set of such characteristics can be referred to as a resource. The terms “resource,” “communications connection,” “channel,” and “communications link” might be used synonymously herein. A network node typically establishes a different resource for each UA or other network node with which it is communicating at any particular time.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram illustrating a wireless communication system that includes a relay node, according to an embodiment of the disclosure.

FIG. 2 is a block diagram of a control plane showing protocol stacks in a user agent, a relay node, and an access node, according to an embodiment of the disclosure.

FIG. 3 is a flowchart illustrating a method of using a relay radio resource configuration entity in a relay node, according to an embodiment of the disclosure.

FIG. 4 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

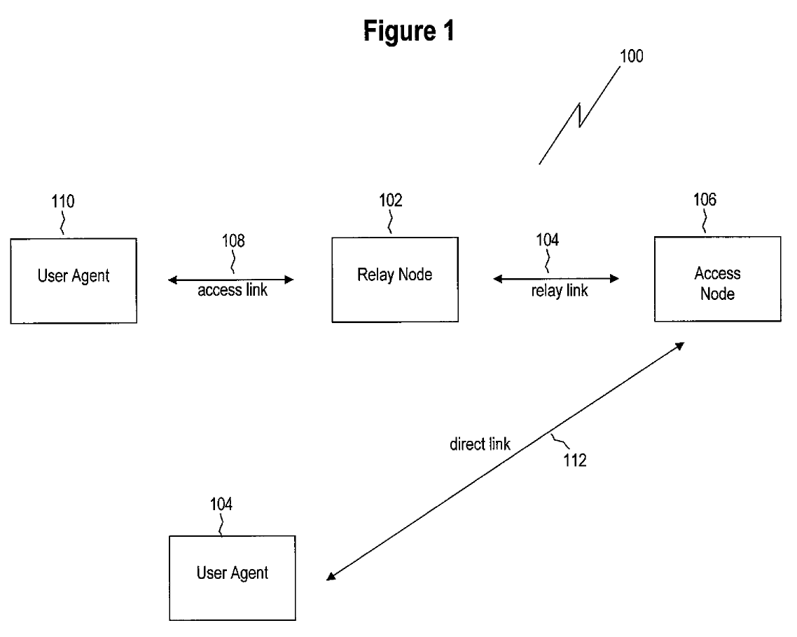

FIG. 1 is a diagram illustrating a wireless communication system 100 using a relay node 102, according to an embodiment of the disclosure. Generally, the present disclosure relates to the use of relay nodes in wireless communications networks. Examples of wireless communication networks include LTE or LTE-Advanced (LTE-A) networks, and all of the disclosed and claimed embodiments could be implemented in an LTE-A network. The relay node 102 can amplify or repeat a signal received from a UA 110 and cause the modified signal to be received at an access node 106. In some implementations of a relay node 102, the relay node 102 receives a signal with data from the UA 110 and then generates a new signal to transmit the data to the access node 106. The relay node 102 can also receive data from the access node 106 and deliver the data to the UA 110. The relay node 102 might be placed near the edges of a cell so that the UA 110 can communicate with the relay node 102 rather than communicating directly with the access node 106 for that cell.

In radio systems, a cell is a geographical area of reception and transmission coverage. Cells can overlap with each other. In the typical example, there is one access node associated with each cell. The size of a cell is determined by factors such as frequency band, power level, and channel conditions. Relay nodes, such as relay node 102, can be used to enhance coverage within or near a cell, or to extend the size of coverage of a cell. Additionally, the use of a relay node 102 can enhance throughput of a signal within a cell because the UA 110 can access the relay node 102 at a higher data rate or a lower power transmission than the UA 110 might use when communicating directly with the access node 106 for that cell. Transmission at a higher data rate creates higher spectrum efficiency, and lower power benefits the UA 110 by consuming less battery power.

Relay nodes, generally, can be divided into three types: layer one relay nodes, layer two relay nodes, and layer three relay nodes. A layer one relay node is essentially a repeater that can retransmit a transmission without any modification other than amplification and slight delay. A layer two relay node can decode a transmission that it receives, re-encode the result of the decoding, and then transmit the re-encoded data. A layer three relay node can have full radio resource control capabilities and can thus function similarly to an access node. The radio resource control protocols used by a relay node may be the same as those used by an access node, and the relay node may have a unique cell identity typically used by an access node. For the purpose of this disclosure, a relay node is distinguished from an access node by the fact that it requires the presence of at least one access node (and the cell associated with that access node) or other relay node to access other components in a telecommunications system. The illustrative embodiments are primarily concerned with layer two or layer three relay nodes. Therefore, as used herein, the term “relay node” will not refer to layer one relay nodes, unless specifically stated otherwise.

In communication system 100, the links that allow wireless communication can be said to be of three distinct types. First, when the UA 110 is communicating with the access node 106 via the relay node 102, the communication link between the UA 110 and the relay node 102 is said to occur over an access link 108. Second, the communication between the relay node 102 and the access node 106 is said to occur over a relay link 104. Third, communication that passes directly between the UA 110 and the access node 106 without passing through the relay node 102 is said to occur over a direct link 112. The terms “access link,” “relay link,” and “direct link” are used in this document according to the meaning described by FIG. 1.

One of the difficulties of using a layer two relay node is that it has no radio resource control mechanism to handle the radio resource management functions, such as avoiding the potential interference among two sets of communications: communications between the UA and the relay node and communications between the UA and the access node.

One mechanism for solving this problem is to create a configuration entity in a protocol stack of the relay node. One of the main functions of the configuration entity is to receive resource configuration information from the access node and then report resource status to the access node.

Thus, the illustrative embodiments provide for a device comprising a layer two relay node having a relay radio resource configuration entity (RRRCE). The RRRCE is configured to receive resource configuration information from an access node. The RRRCE further may be configured to report resource status to the access node. The following figures, text, and claims further describe the RRRCE.

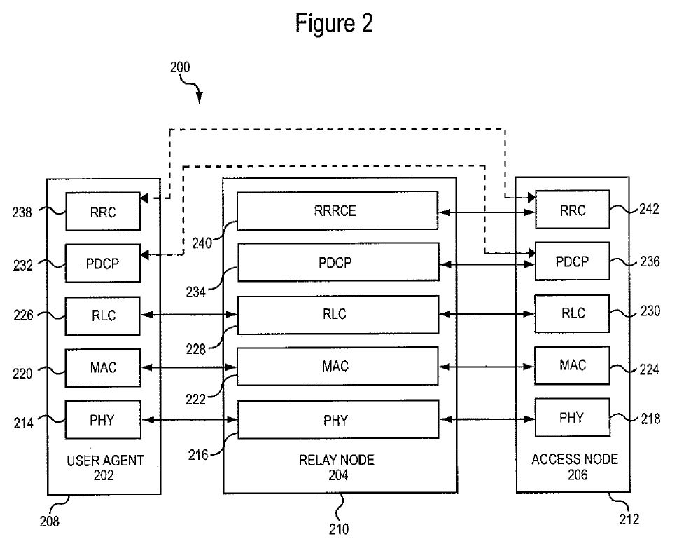

FIG. 2 is a block diagram of a control plane 200 showing protocol stacks in a UA 202, a relay node 204, and an access node 206, according to an embodiment of the disclosure. UA 202 can correspond to UA 110 in FIG. 1. Likewise, relay node 204 can correspond to relay node 102 and access node 206 can correspond to access node 106 in FIG. 1. Thus, UA 202, relay node 204, and access node 206 can have similar functions and perform similar methods to those described with respect to FIG. 1.

Additionally, FIG. 2 shows that each of UA 202, relay node 204, and access node 206 has a corresponding protocol stack. Thus, UA 202 has UA protocol stack 208, relay node 204 has relay node protocol stack 210, and access node 206 has access node protocol stack 212. A protocol stack is a software or hardware implementation of a networking protocol suite. The suite is the definition of the protocols, and the stack is the hardware or the software implementation of the protocols. Individual protocols within a suite are often, but not always, designed with a single purpose in mind. Because each protocol module usually interacts with two others, protocol modules are commonly portrayed as layers in a stack of protocols. The lowest protocols deal with the “low level,” or physical interaction, of the hardware. Thus, for example, physical layer 214 (PHY 214) is the hardware layer in UA protocol stack 208, physical layer 216 (PHY 216) is the hardware layer in relay node protocol stack 210, and physical layer 218 (PHY 218) is the hardware layer in access node protocol stack 212. In practical implementation, protocol stacks such as those shown in FIG. 2 are often divided into three major sections: media, transport, and application. One skilled in the art will appreciate that the depiction of each layer separate from one another is for simplicity of explanation and in some embodiments the layers may not be so clearly defined.

In the illustrative embodiments shown in FIG. 2, relay node 204 interacts with both UA 202 and access node 206 at three different layers. For example, physical layer 216 interacts with physical layer 214 and physical layer 218. Similarly, medium access control (MAC) layer 222 in relay node protocol stack 210 interacts with medium access control (MAC) layer 220 in UA protocol stack 208. Likewise, medium access control (MAC) layer 222 interacts with medium access control (MAC) layer 224 in access node protocol stack 212. In the third layer from the lowest layer, radio link control (RLC) layer 228 in relay node protocol stack 210 interacts with radio link control (RLC) layer 226 in UA protocol stack 208. Similarly, radio link control layer 228 interacts with radio link control (RLC) layer 230 in access node protocol stack 212.

However, at this point, complexities in the interactions amongst these layers should be pointed out. UA 202 could attempt to communicate with both relay node 204 and access node 206. For example, UA packet data control protocol 232 can communicate with access node packet data control protocol 236 directly. Likewise, UA radio resource control (RRC) 238 can communicate directly with access node radio resource control (RRC) 242. These last two interactions are shown by the phantom lines in FIG. 2. Simultaneous communication could create undesirable interference.

Still further, in the case where relay node 204 is a layer two relay node, layer two relay nodes may not implement packet data control protocol (PDCP). Nevertheless, in the control plane between the relay node and the access node, the PDCP might be required for communication between the RRRCE and the RRC.

One method of solving the above problem of interference is for most radio link control functions to be implemented in the relay node 204. Implementing these control functions in a relay node does not necessarily mean that the relay node is a layer 3 relay node. For example, layer 3 relay nodes generally have full mobility support, paging functions, and other functions that are not necessary for implementing most radio link control functions in the relay node. Although the embodiments described below contemplate use of layer 1 or layer 3 relay nodes, the embodiments described below generally relate to layer 2 relay nodes.

Several reasons exist for implementing radio link control functions in the relay node 204. For example, the relay link and the access link may have different channel conditions, so different scheduling should be allowed. In another example, segmentation of the medium access control transport blocks should be supported in the relay node 204. The different channel conditions and antenna configurations between the relay link and the access link will cause different modulation and coding schemes for transmissions. Therefore, the transport block sizes may differ between the access link and the relay link, and segmentation is used to support different transport block sizes. Still further, due to radio link control segmentation, the buffering of the medium access control packet data units should be supported in the radio link control function. Yet further, automatic repeat request (ARQ) is useful for reliable transmission between both the access link and the relay link. Finally, a packet data control protocol might not be implemented in the relay node protocol stack 210 with respect to the UA protocol stack 208, because layer two relay nodes may not need to deal with data packets at the internet protocol (IP) level.

One method of implementing the equivalent of radio link control functions in a layer two relay node, such as relay node 204 in this example, is to use relay radio resource configuration entity (RRRCE) 240, which is implemented as either hardware, software, firmware or a any combination thereof in the relay node protocol stack 210. If implemented in software, the RRRCE 240 is stored in the form of computer readable instructions in a tangible computer usable medium.

The RRRCE 240 in the relay node 204 receives resource configuration information from the access node 206, and specifically receives this information from access node radio resource control (RRC) 242. The resource configuration information includes the assigned physical downlink shared channel (PDSCH), physical uplink shared channel (PUSCH), and physical downlink control channel (PDCCH) resources from the access node 206 to be used for scheduling over the access link. The access node 206 may update this information, and should signal the updated information to the relay node 204.

For each UA uplink, the access node 206 may send the uplink resource configuration information to the relay node. The uplink resource configuration information at least includes the physical uplink control channel, sounding reference signals, and scheduling request (SR) configuration for the access link. The resource configuration information also can include a dedicated preamble for the relay node initial access. The signaling transmission is directly dedicated to each UA 202, but the signaling transmission may or may not be made via the relay node 204. The access node 206 should also transmit this information to the relay node 204 so the access link can work properly. The access node 206 may update this information and should signal the updated information to the UA 202 and the relay node 204. Thus, the relay node may be further configured to process received resource configuration information for use by the relay node, and not just to relay such information to the UA 202 or to the access node 206.

Further, the RRRCE 240 reports the resource status to the access node 206, such as the number of resource blocks used or required for the relay node 204. The RRRCE 240 also tries to maintain the uplink (UL) timing alignment (TA) for UAs in RRC_CONNECTED mode, but connected via the relay node 204. In an illustrative embodiment, the RRRCE 240 first generates the uplink timing offset values via the layer one estimations, and then configures the medium access control (MAC) 222 to transmit timing alignment commands to the UAs. Finally, the RRRCE 240 maintains the list of UA identifications in RRC_CONNECTED mode, but connected via the relay node 204.

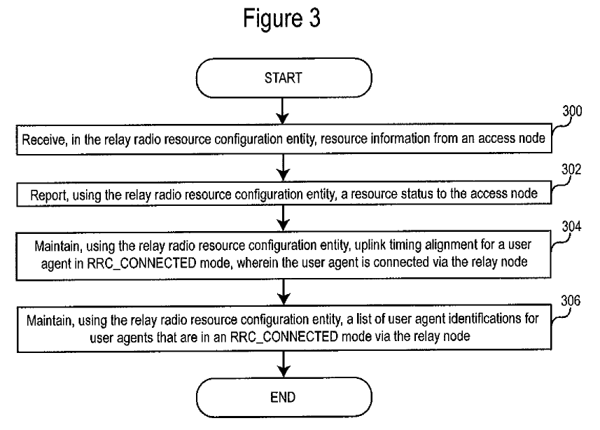

FIG. 3 is a flowchart illustrating a method of using a relay radio resource configuration entity in a relay node, according to an embodiment of the disclosure. The illustrative method shown in FIG. 3 can be implemented in a relay node, such as relay node 102 in FIG. 1 or relay node 204 shown in FIG. 2. In particular, the process shown in FIG. 3 can be implemented in a relay radio resource configuration entity of a layer two relay node, such as relay radio resource configuration entity 240 of FIG. 2.

The process begins as the relay node receives, in the relay radio resource configuration entity (RRRCE), resource information from an access node (block 300). The resource configuration information can be at least one of assigned physical downlink shared channel (PDSCH), physical uplink shared channel (PUSCH), and physical downlink control channel (PDCCH) resources from the access node to be used for scheduling in the relay node; uplink physical uplink control channel (PUCCH), sounding reference signals (SRS), and scheduling request (SR) configuration for an access link; and a dedicated preamble for the relay node initial access. The relay node then reports, using the RRRCE, a resource status to the access node (block 302). The resource status could be, for example, a number of resource blocks used for the relay node.

The following two steps can be implemented before or after reporting a resource status, as in block 302. In either case, the relay node maintains, using the RRRCE, uplink timing alignment for a UA in RRC_CONNECTED mode, wherein the UA is connected via the relay node (block 304). This particular step can be broken down in two sub-steps. For example, the RRRCE can maintain the uplink timing alignment by first generating uplink timing offset values via a layer one estimation, and then configuring a medium access control to transmit timing alignment commands to the UA. In the other step that can be implemented before or after reporting a resource status, the relay node maintains, using the RRRCE, a list of UA identifications for UAs that are in an RRC_CONNECTED mode via the relay node (block 306). The process terminates thereafter.

In an illustrative embodiment, a protocol stack is stored on the relay node and the relay radio resource configuration entity (RRRCE) is in a first layer of the protocol stack. In a further illustrative embodiment, the RRRCE corresponds to a radio resource control layer of a second protocol stack stored on the access node.

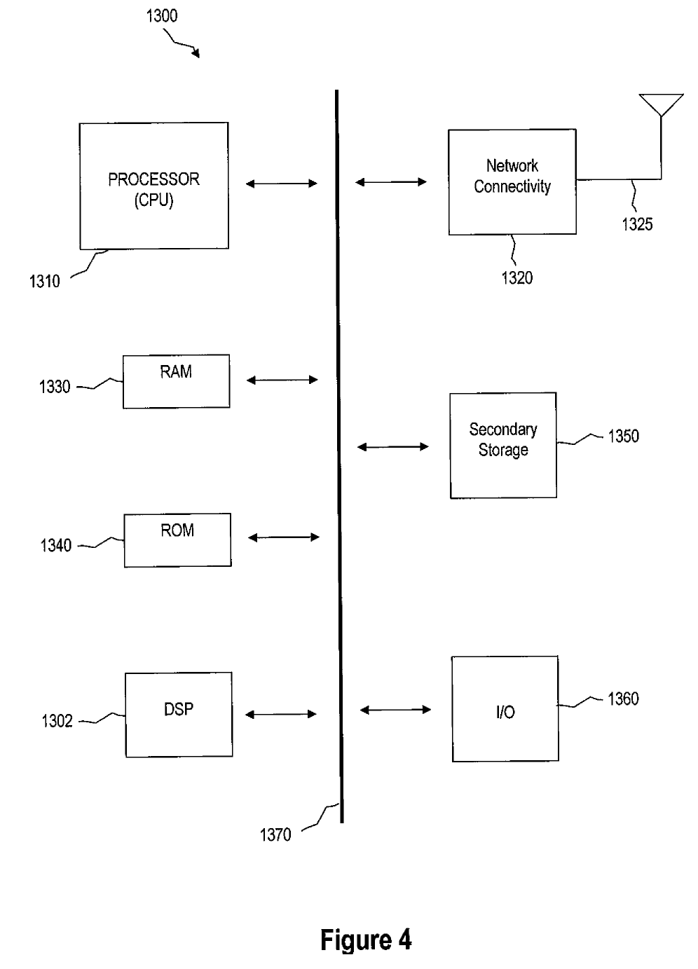

The UA 110 and other components described above might include a processing component that is capable of executing instructions related to the actions described above. FIG. 4 illustrates an example of a system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. These components might communicate with one another via a bus 1370. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing, such as a digital signal processor (DSP) 1302. Although the DSP 1302 is shown as a separate component, the DSP 1302 might be incorporated into the processor 1310.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one CPU 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information. The network connectivity devices 1320 might also include one or more transceiver components 1325 capable of transmitting and/or receiving data wirelessly.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input devices. Also, the transceiver 1325 might be considered to be a component of the I/O devices 1360 instead of or in addition to being a component of the network connectivity devices 1320.

The following are incorporated herein by reference for all purposes: 3rd Generation Partnership Project (3GPP) Technical Specification (TS) 36.813 and 3GPP TS 36.814.

Thus, the illustrative embodiments provide for a device comprising a layer two relay node having a relay radio resource configuration entity. The relay radio resource configuration entity is configured to receive resource configuration information from an access node and is further configured to report resource status to the access node.

The illustrative embodiments similarly provide for a method implemented in a layer two resource node having a relay radio resource configuration entity. The method includes receiving, in the relay radio resource configuration entity, resource configuration information from an access node.

The illustrative embodiments similarly provide for a tangible computer readable medium storing computer readable instructions for implementing a computer-implemented method in a layer two resource node having a relay radio resource configuration entity. Such a computer implemented method includes receiving, in the relay radio resource configuration entity, resource configuration information from an access node. The computer implemented method further includes reporting, using the relay radio resource configuration entity, a resource status to the access node.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A device comprising:
a relay node having a relay radio resource configuration entity, wherein the relay radio resource configuration entity is configured to receive resource configuration information from an access node.

2. The device of claim 1 wherein the relay radio resource configuration entity is further configured to report resource status to the access node.

3. The device of claim 1 wherein the relay radio resource configuration entity is further configured to maintain uplink timing alignment for a user agent in RRC_CONNECTED mode.

4. The device of claim 3 wherein the relay radio resource configuration entity is configured to maintain the uplink timing alignment by generating uplink timing offset values via a layer one estimation and then configure a medium access control to transmit timing alignment commands to the user agent.

5. The device of claim 1 wherein the resource configuration information comprises at least one of assigned physical downlink shared channel (PDSCH), physical uplink shared channel (PUSCH), and physical downlink control channel (PDCCH) resources from the access node to be used for scheduling in the relay node; uplink physical uplink control channel (PUCCH), sounding reference signals (SRS), and scheduling request (SR) configuration for an access link; and a dedicated preamble for the relay node initial access.

6. The device of claim 1 wherein the resource status comprises a number of resource blocks used for the relay node.

7. The device of claim 1 wherein the relay radio resource configuration entity maintains a list of user agent identifications for user agents that are in an RRC_CONNECTED mode.

8. The device of claim 1 wherein a protocol stack is stored on the relay node and wherein the relay radio resource configuration entity is in a first layer of the protocol stack.

9. The device of claim 8 wherein the relay radio resource configuration entity corresponds to a radio resource control layer on the access node, and wherein the relay radio resource configuration entity receives the resource configuration information from the radio resource control on the access node.

10. The device of claim 1 wherein the relay radio resource configuration entity is further configured to receive updated resource configuration information from the access node.

11. The device of claim 1 wherein the relay node is further configured to process received resource configuration information for use by the relay node.

12. A method implemented in a relay node having a relay radio resource configuration entity, the method comprising:
receiving, in the relay radio resource configuration entity, resource configuration information from an access node.

13. The method of claim 12 further comprising:
reporting, using the relay radio resource configuration entity, a resource status to the access node.

14. The method of claim 12 further comprising:
maintaining, using the relay radio resource configuration entity, uplink timing alignment for a user agent in RRC_CONNECTED mode, wherein the user agent is connected via the relay node.

15. The method of claim 14 wherein the relay radio resource configuration entity maintains the uplink timing alignment by:
generating uplink timing offset values via a layer one estimation; and
thereafter configuring a medium access control to transmit timing alignment commands to the user agent.

16. The method of claim 12 wherein the resource configuration information comprises at least one of assigned physical downlink shared channel (PDSCH), physical uplink shared channel (PUSCH), and physical downlink control channel (PDCCH) resources from the access node to be used for scheduling in the relay node; uplink physical uplink control channel (PUCCH), sounding reference signals (SRS), and scheduling request (SR) configuration for an access link; and a dedicated preamble for the relay node initial access.

17. The method of claim 12 wherein the resource status comprises a number of resource blocks used for the relay node.

18. The method of claim 12 further comprising:
maintaining, using the relay radio resource configuration entity, a list of user agent identifications for user agents that are in an RRC_CONNECTED mode via the relay node.

19. The method of claim 12 wherein a protocol stack is stored on the relay node and wherein the relay radio resource configuration entity is in a first layer of the protocol stack.

20. The method of claim 19 wherein the relay radio resource configuration entity corresponds to a radio resource control layer on the access node.

21. The method of claim 19 wherein the relay radio resource configuration entity corresponds to a radio resource control layer on the access node, and wherein the relay radio resource configuration entity receives the resource configuration information from the radio resource control on the access node.

22. The method of claim 12 further comprising:
receiving updated resource configuration information from the access node.

23. The method of claim 12 further comprising:
processing received resource configuration information for use by the relay node.

24. A computer readable medium storing computer readable instructions that, when executed, implement a method in a relay node having a relay radio resource configuration entity, the method comprising:
receiving, in the relay radio resource configuration entity, resource configuration information from an access node.

25. The computer readable medium of claim 24 wherein the method further comprises:
reporting, using the relay radio resource configuration entity, a resource status to the access node.

26. The computer readable medium of claim 24 wherein the method further comprises:
maintaining, using the relay radio resource configuration entity, uplink timing alignment for a user agent in RRC_CONNECTED mode, wherein the user agent is connected via the relay node.

27. The computer readable medium of claim 26 wherein the relay radio resource configuration entity maintains the uplink timing alignment by:
generating uplink timing offset values via a layer one estimation; and
thereafter configuring a medium access control to transmit timing alignment commands to the user agent.

28. The computer readable medium of claim 24 wherein the method further comprises:
maintaining, using the relay radio resource configuration entity, a list of user agent identifications for user agents that are in an RRC_CONNECTED mode via the relay node.

29. The computer readable medium of claim 24 wherein the relay radio resource configuration entity corresponds to a radio resource control layer on the access node, and wherein, in the method, the relay radio resource configuration entity receives the resource configuration information from the radio resource control on the access node.

30. The computer readable medium of claim 24 wherein the method further comprises:
receiving updated resource configuration information from the access node.

31. The computer readable medium of claim 24 wherein the method further comprises:
processing received resource configuration information for use by the relay node.
